(19) United States
(12) Patent Application Publication
(10) Pub. No.: US 2009/0312044 A1
(43) Pub. Date: Dec. 17, 2009

(54) Channel Estimation, Scheduling, and Resource Allocation using Pilot Channel Measurements

(76) Inventor: Ari Hottinen, Espoo (FI)

Correspondence Address: SLATER & MATSIL, L.L.P., 17950 PRESTON RD, SUITE 1000, DALLAS, TX, 75252-5793, US

(21) Appl. No.: 12/138,675

(22) Filed: Jun. 13, 2008

(51) Int. Cl. H04Q 7/20

(52) U.S. Cl. 455/509

(57) ABSTRACT

A wireless communication system is disclosed that includes forming one or more beam patterns by a transmitter at a first time, where the beam patterns are made up of a first set of beam patterns used to transmit data during the first time, and a second set of beam patterns used to transmit data during a subsequent time. A pilot signal is transmitted on each of the beam patterns and is detectable and decodable by one or more receivers. The receivers test the quality of the beam patterns and transmit an indicator to the transmitter that relates to one of the beam patterns that has a high channel quality. The transmitter determines channel estimation, transmission scheduling, and/or resource allocation based, at least in part, on the indicator.

### TECHNICAL FIELD

The present invention relates, in general, to wireless communications systems and, more particularly, to channel estimation, scheduling, and resource allocation using pilot channel measurements.

### BACKGROUND

Many modern wireless communications systems allocate system resources based, at least in part, on pilot channel measurements. For example, scheduling decisions are often based on pilot channel measurements in current third generation (“3G”) networks such as high speed data packet access (“HSDPA”) networks, and networks based on the Institute of Electrical and Electronics Engineers (“IEEE”) 802.16e specification, which is incorporated herein by reference. In such systems, base stations or other network nodes (sometimes referred to herein generically as “transmitters”) transmit a pilot channel. User equipment or another node in the network (sometimes referred to herein generically as “receivers” or “access terminals (“AT”)”) scan the various signals in its given area attempting to detect or decode each signal into a recognizable pilot channel. Once a pilot channel is found, the receiver, among other things, evaluates the strength or the quality of the pilot channel(s), or derives a channel quality indicator (“CQI”) using one or more pilot channels, and reports some result of that test or derivation back to the transmitter.

Using the pilot channel measurement made available to the transmitter, the transmitter may then allocate resources for communicating with the receiver. Thus, in such systems, resource allocation is based on some kind of feedback or closed-loop control provided by the receiver. Explicit feedback is typically used in frequency division duplex (“FDD”) systems, wherein channel reciprocity does not hold. However, in time division duplex (“TDD”) systems, or in systems wherein channel reciprocity holds, the pilot channel measurements made on one duplex direction may be used at least partially in allocating transmission resources in another duplex direction. In such systems, closed-loop control, or feedback, and subsequent resource allocation is made within the same transceiver unit, although it is also possible to obtain feedback from another spatially separate receiver. In TDD systems, such feedback could include information related to interference measurements at the receiver, or to information on available resources.

Problems arise in these systems because making such resource allocations or optimizations in pseudo-randomly time-varying channels is extremely complicated and threatens to increase the complexity at the receiver level. The goal in developing wireless system advances is typically to assure that simplicity is maintained at the AT and at the system level. For example, the measurements at the AT should be scalable in the sense that when more resources are added to a transmitter, the operations in the AT remain essentially unaffected.

Pseudo-random channels typically occur, for example, in connection with random transmit beam forming from a transmitter to a receiver or AT. Random transmit beam forming is generally used as an effective technique for increasing channel selectivity either in the frequency or time domains. In the time domain, it can be used, for example, in converting a static channel into a time varying channel, which is generally better for delay differentiated scheduling, or for services that require strict delay requirements, as the number of consecutive poor channel conditions is reduced. Thus, problems arise in determining suitable transmission channels or resources in a wireless multi-antenna system in order to maintain improved performance while keeping comparable simplicity at the AT and system level.

### SUMMARY OF THE INVENTION

These and other problems are generally solved or circumvented, and technical advantages are generally achieved, by embodiments of the present invention, which include a transmitter for selecting or estimating a channel, beams, power information, modulation information, coding information, or transport format (including bit allocation and the like), for example, and methods for feeding back information or measurements for such purposes.

The representative methods may also include methods for a wireless communication system that includes forming one or more beam patterns at a first time by a transmitter, where the beam patterns are made up of at least a first set of beam patterns used to transmit data during the first time or channel resource, and a second set of at least partly different beam patterns (compared to the first set) provisioned to transmit data during a subsequent time or channel resource. The methods also include transmitting a pilot signal on a plurality of the beam patterns. An indicator is received from one or more receivers, wherein the indicator relates at least partly to one of the beam patterns or transmission resources of the second set. The transmitter will then determine transmission scheduling and/or resource allocation based, at least in part, on the indicator.

In accordance with another embodiment of the present invention, a transmitter includes a beam forming module configured to direct formation of one or more radio frequency (“RF”) beam patterns, a pilot module configured to generate pilot signals transmittable using the RF beam patterns, a decoder configured to decode feedback signals from one or more receivers, wherein the feedback signals relate to channel characteristics of some of the RF beam patterns, a scheduling module configured to schedule data transmission to the one or more receivers based at least in part on the decoded feedback signal, and a resource allocation module configured to allocate ones of the one or more RF beam patterns for the data transmission. The transmitter also includes a processor configured to run each of the beam forming module, the pilot module, the scheduling module, and the resource allocation module.

In accordance with a further embodiment of the present invention, a receiver is made up from an antenna configured to receive one or more beam patterns transmitted by a transmitter, wherein the one or more beam patterns include at least a first set of beam patterns used to transmit data during a first time, and a second set of beam patterns potentially used to transmit data during a subsequent time. It also includes a processor, a decoder configured to decode one or more pilot signals transmitted on the beam patterns, a decision module run on the processor and configured to determine the quality of the beam patterns using pilot measurements and possibly also resource information, a quality indicator module run on the processor and configured to generate at least one quality indicator based on results output from the decision module, wherein the quality indicator relates to one of the one or more beam patterns, and a signaling unit configured to signal the quality indicator before transmission to the transmitter.

In accordance with a further embodiment of the present invention, a computer program product has a computer readable medium with computer program logic recorded thereon. The computer program product includes code for forming one or more beam patterns by a transmitter at a first time, wherein the beam patterns are made up of at least a first set of beam patterns used to transmit data during the first time, and a second set of beam patterns used to transmit data during a subsequent time. It also includes code for transmitting a pilot signal on each of the beam patterns, code for receiving an indicator from one or more receivers, wherein the indicator relates to one of the beam patterns having a high channel quality, and code for determining transmission scheduling and/or resource allocation based, at least in part, on the indicator.

One advantage of the various embodiments of the present invention is that each AT or user equipment already knows the channel quality or channel performance (e.g., throughput and the like) of a future time slot during signal reception. Another advantage of the present invention is that the transmitter can select whichever time slot and/or beam pattern shows a better performance characteristic, whether that is the current data transmission beam or a future data transmission beam. Thus, transmission resources need not be wasted on a poor-quality current channel of a given user, if the future channel quality is estimated to be better. The same channel (time slot) may then be allocated to another user. Moreover, if several users transmit feedback in a similar way, the transmission resources (e.g., time slots, frequency slots) may be determined jointly for all users, so as to improve performance or fairness accordingly.

A further advantage of the present invention is that, with beam-specific pilot signals in at least the second set, the receivers do not need to know how the beams are formed at the transmitters. The number of beam patterns or the formation of beam patterns (beam shapes or beam forming coefficients) may increase or decrease when transmission resources are upgraded or changed. Therefore, the solution is scalable to any number of beams/array elements without changing the receiver operations.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram illustrating a wireless communications system configured according to one embodiment of the present invention;

FIG. 2 is a block diagram illustrating a wireless communications system configured according to one embodiment of the present invention;

FIG. 3 is a block diagram illustrating a wireless communications system configured according to one embodiment of the present invention;

FIG. 4 is a block diagram of a transmitter and a receiver configured for a wireless communications system according to one embodiment of the present invention;

FIG. 5 is a graph demonstrating advantages in accordance with one embodiment of the present invention;

FIG. 6 is a diagram illustrating an eight-element beam array transmittable from a transmitter operable in a wireless communications network configured according to one embodiment of the present invention;

FIG. 7 is a flowchart illustrating exemplary steps executed to implement one embodiment of the present invention; and

FIG. 8 illustrates a computer system adapted for use with embodiments of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

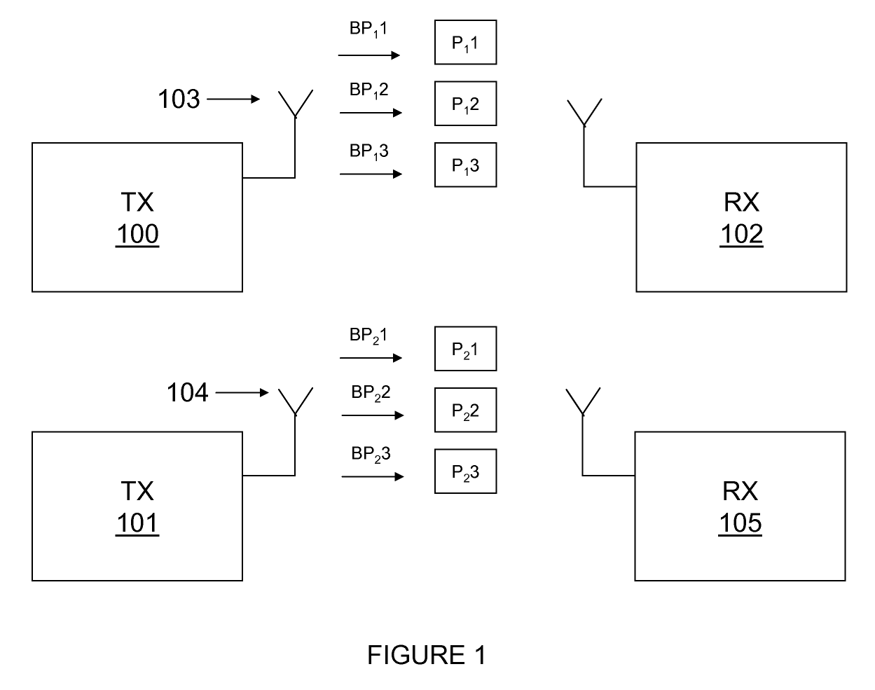

FIG. 1 is a block diagram illustrating wireless communications system configured according to one embodiment of the present invention. In example operation, wireless communications system includes transmitters (“Tx”) 100, 101, antennae 103, 104, and multiple receivers or ATs, such as receivers (“Rx”) 102, 105. At any given time or time interval, Tx 100 transmits a set of pilot signals, P₁1, P₁2, P₁3 using multiple beam patterns, BP₁1, BP₁2, BP₁3 over antenna 103. Similarly, Tx 101 transmits a set of pilot signals, P₂1, P₂2, P₂3, using multiple beam patterns, BP₂1, BP₂2, BP₂3, over antenna 104.

Each of the beam patterns may include a single beam pattern or a set of two or more beam patterns formed (e.g., via digital or analog beam forming). In any of the beam patterns, during a first time, the beam pattern is used to transmit data and pilot symbols to a given user. Similarly, during the first time at least one of the different beam patterns is used to transmit only pilot/probing symbols. For example, at time, t, some of the beam patterns are used to transmit data and pilot signals, while at least one different one of is used to transmit only pilot/probing symbols. At a later time, t+1, those same beam patterns may be used for the other purpose. It should be noted that probing beams may be sent during a given time slot using a beam pattern or set of beam patterns for any of the future time slots.

As Rx 102 operates within the coverage area of the Txs 100, 101, the first determination is made as to which of the Txs Rx 102 should select for operation. For purposes of this example, Rx 102 is operating further into the coverage area of Tx 100. The Rx 102 receives and decodes pilot signals P₁1, P₁2, P₁3 and evaluates or tests beam patterns BP₁1, BP₁2, BP₁3 to determine which beam pattern or set of beam patterns therein has the highest quality or utility at that time with the available transmission resources (such as power, modulation, coding resources, and the like). After analyzing and comparing the signal quality of beam patterns BP₁1, BP₁2, BP₁3, the Rx 102 transmits feedback to Tx 100. The Tx 100 uses this feedback information from Rx 102 to make resource allocation decisions and scheduling decisions.

For example, the Rx 102 measures the channel power at time t1 using beams BP₁1, BP₁2, BP₁3 to determine both the current channel power and the assumed future channel power at a time t2. For the sake of this example, the Rx 102 measures one of the beams, BP₁1, for example, which is not currently used for transmitting data, to determine which has the highest channel power. Having made the measurements, the Rx 102 instructs the Tx 100 to schedule any data transmissions for the time slot t2, thus, prompting the Tx 100 to allocate a beam pattern, such as BP₁1, as the resource for that data transmission. Therefore, at least one resource control decision affecting a future transmission is affected by this pilot structure. Naturally, the transmission may occur also on other beams or during other time slots or channel uses. The same user may transmit on other beams with a different data rate or a different power, or the beams may be allocated to another user. Moreover, the receiver may signal the relative or absolute channel quality related to a number of “future” or “current” beams, and let the transmitter decide how to make best use of the available feedback.

It should be noted that the different sets of beam patterns from different antenna, such as antennae 103, 104, may be intended for two different receivers of ATs (i.e., user-specific beam indexing). For example, with reference to FIG. 1, beam patterns BP₁1, BP₁2, BP₁3 may be intended for Rx 102, while beam patterns BP₂1, BP₂2, BP₂3 may be intended for Rx 105.

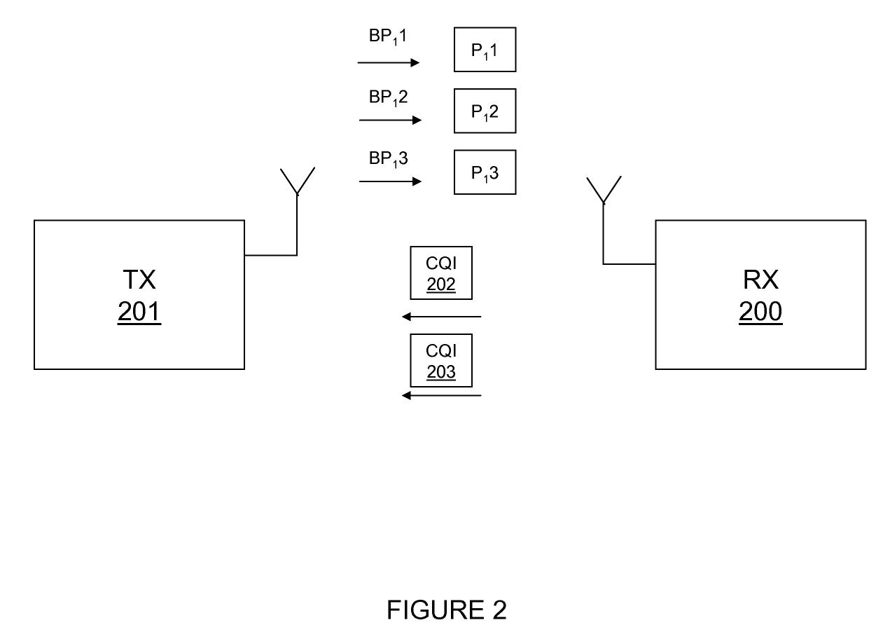

FIG. 2 is a block diagram illustrating a wireless communications system configured according to one embodiment of the present invention. Similar to operation of wireless communications system of FIG. 1, an Rx 200 receives pilot signals P₁1, P₁2, P₁3 over beam patterns BP₁1, BP₁2, BP₁3 from a Tx 201 and measures the signal qualities of each of beam patterns BP₁1, BP₁2, BP₁3. After determining the highest quality beam pattern, the Rx 200 transmits CQI 202 based on the conventional pilot signal that is used in wireless communications systems for channel estimation and synchronization, and also transmits CQI 203 based on the secondary pilot signal (i.e., on of the pilot signals, P₁1-P₁M, carried on one of the beam patterns or sets of beam patterns, BP₁1-BP₁N, that are known to be available at a later time for data transmission). The Tx 201, thereafter, uses at least CQI 203, or both CQIs 202, 203, to make scheduling and resource allocation decisions.

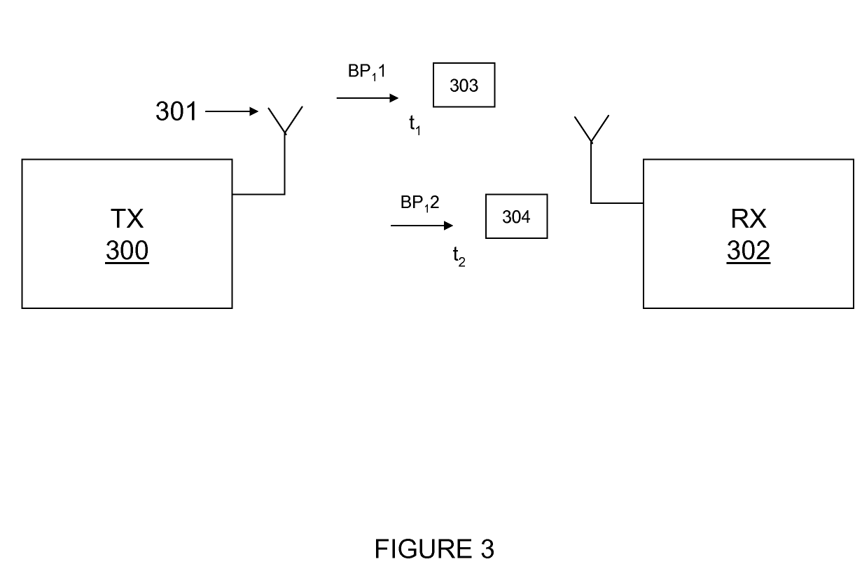

Turning now to FIG. 3, a wireless communications system is illustrated configured according to one embodiment of the present invention. A Tx 300 transmits a pilot set 303, which includes pilot signals transmitted using a set of beam patterns over antenna 301. An Rx 302 receives and decodes the pilot set 303 and tests the quality of the beam patterns of the pilot set 303. The Rx 302 also knows the later times that some of the beam patterns of the pilot set 303 are scheduled to be used for transmitting data. The Rx 302 determines which of the beam patterns in the pilot set 303 is strongest and transmits a signal to the Tx 300 indicating the specific time, t2, that the Tx 300 should schedule the data transmission. The Tx 300 uses this scheduling information from the Rx 302 in order to make resource allocation decisions. The Tx 300 transmits data block 304 at the time t2. In making this transmission, the Tx 300 allocates the beam pattern that showed the best channel quality at time t1.

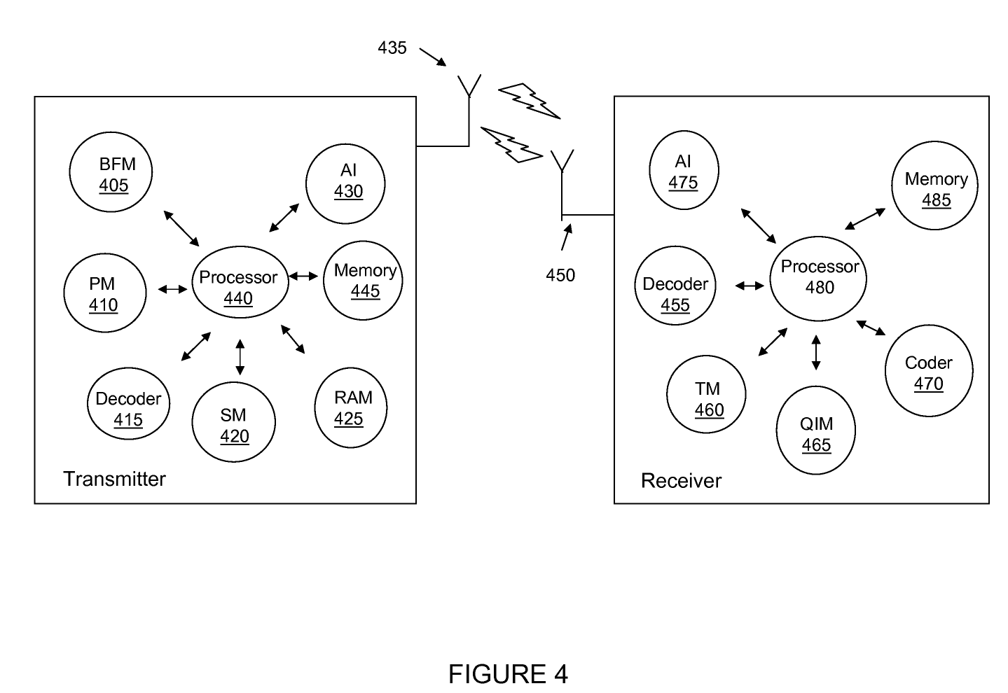

FIG. 4 is a block diagram of a transmitter and a receiver configured for a wireless communication system according to one embodiment of the present invention. The transmitter includes a beam forming module (“BFM”) 405 configured to direct formation of one or more radio frequency (“RF”) beam patterns. The transmitter also includes a pilot module (“PM”) 410 configured to generate pilot signals transmittable using one or more RF beam patterns. The transmitter also includes a decoder 415 configured to decode feedback signals from one or more receivers, wherein the feedback signals relate to one or more RF beam patterns having a high channel quality. The feedback signals include a channel quality indicator (“CQI”) that provides a signal identifying one or more RF beam patterns having the high channel quality, and/or a designation for the data transmission at a first time, when one or more of the RF beam patterns having the high channel quality is used to transmit data during the first time, or a subsequent time, when one or more of the RF beam patterns having the high channel quality is used to transmit data during the subsequent time.

The transmitter also includes a scheduling module (“SM”) 420 configured to schedule data transmission to one or more receivers based at least in part on the decoded feedback signal. The transmitter also includes a resource allocation module (“RAM”) 425 configured to allocate one or more RF beam patterns for data transmission. An antennae interface (“AI”) 430 of the transmitter is configured to enable communication between the transmitter and one or more antennae 435, wherein one or more antennae 435 transmit RF signals to generate one or more RF beam patterns, and wherein the feedback signals are received at the one or more antennae 435. The transmitter also includes a processor 440 configured to control the modules and subsystems of the transmitter and a memory 445 that stores programs and data of a temporary or more permanent nature.

The receiver includes an antenna 450 configured to receive one or more beam patterns transmitted by a transmitter, wherein the one or more beam patterns have a first set of beam patterns used to transmit data during a first time, and a second set of beam patterns used to transmit data during a subsequent time. The receiver also includes a decoder 455 configured to decode one or more pilot signals transmitted on the one or more beam patterns. The receiver also includes a test module (“TM”) 460 configured to test a quality of the one or more beam patterns. The receiver also includes a quality indicator module (“QIM”) 465 configured to generate a quality indicator based on results output from the test module 460, wherein the quality indicator relates to one of the beam patterns having a high channel quality.

The receiver also includes a coder 470 configured to encode the quality indicator in the form of a feedback signal before transmission to the transmitter. The feedback signal includes one of a channel quality indicator (“CQI”), a signal identifying one of the beam patterns having the high channel quality, and/or a designation for receiving data transmission from the transmitter at one of a first time, when one or more beam patterns having the high channel quality is in the first set, or a subsequent time, when one or more beam patterns having the high channel quality is in the second set. An antennae interface (“AI”) 475 of the receiver is configured to enable communication between the receiver and the antenna 450. The receiver also includes a processor 480 configured to control the modules and subsystems of the receiver and a memory 485 that stores programs and data of a temporary or more permanent nature.

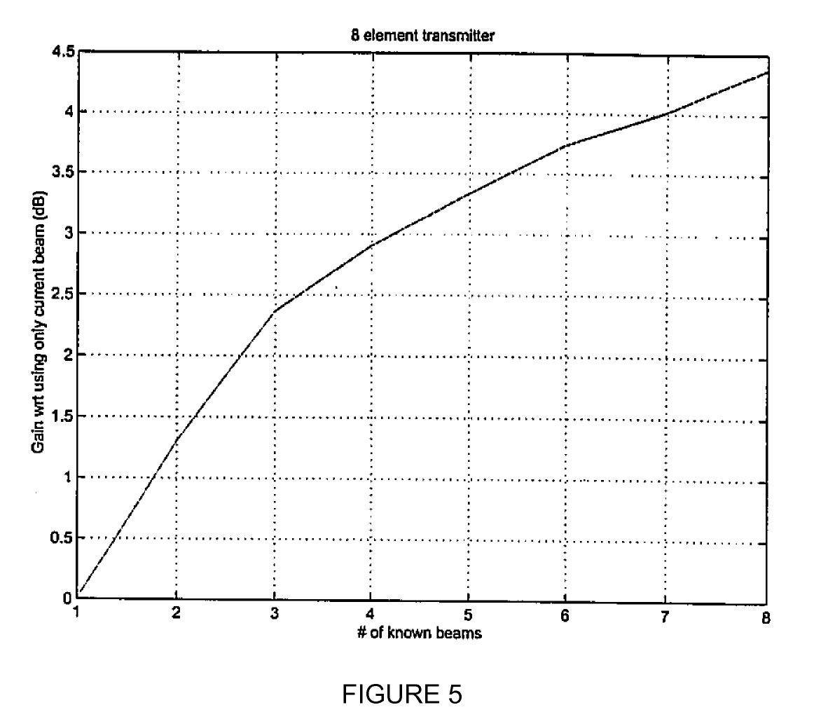

Turning now to FIG. 5, illustrated is a graph demonstrating advantages in accordance with one embodiment of the present invention employing a static channel with random beam forming using up to eight array elements. The experiment used from two to eight beams, the current pilot beam plus up to seven future beams, which were each associated with pilot sequences. An AT is able to test and signal the transmitter the best of a given number of the future beams. If only the next beam is known (i.e., one future beam), the performance gain resulted in about 1.3 decibels (“dB”). However, where eight random beams, taken in this experiment from the columns of an eight dimensional fast Fourier transform (“FFT”) matrix, were known, the performance gain resulted in almost 4.5 dB. A performance gain of this magnitude is essentially equivalent an entire selection diversity gain.

It should be noted that in the various embodiments of the present invention, the receiver does not need to know the beam coefficients of any of the transmitted beam patterns. The receiver does not even need to know how many elements the transmitter has, although this information may affect the optimal choice of proposed pilots at the first time, t1. Thus, various embodiments of the present invention may provide for the receiver to know the beam coefficients and/or the number of elements of the transmitter by some means.

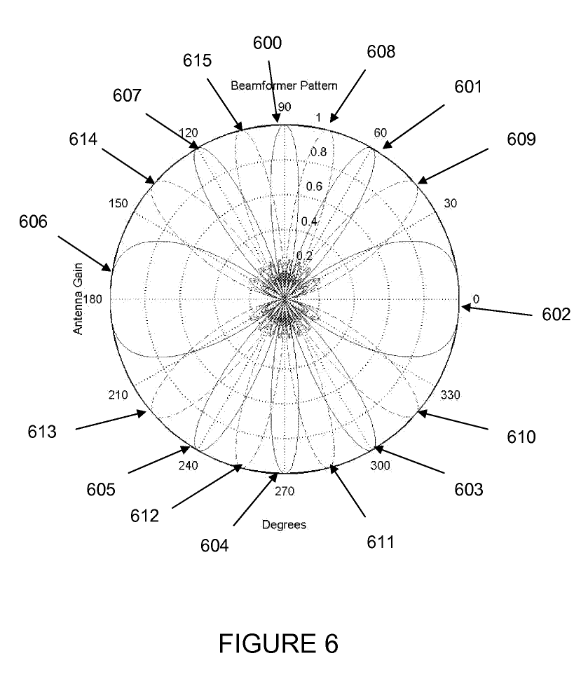

FIG. 6 is a diagram illustrating an eight-element beam array transmittable from a transmitter operable in a wireless communications network configured according to one embodiment of the present invention. In implementing the various embodiments of the present invention, various transmitters may transmit beam patterns having eight beams. For purposes of this example, beams 600-607 are orthogonal and are used to transmit data during a first time, t1. Beams 608-615 are different than beams 600-607, but are still orthogonal and used to probe channels during the first time, t1, for use during a subsequent time, t2.

It should be noted that while FIG. 6 illustrates orthogonal beam patterns, the beam patterns transmitted in the various additional and/or alternative embodiments of the present invention do not have to be orthogonal or evenly spaced in the DoT domain. Also, the beam patterns may be arbitrary, and the antenna elements may be placed arbitrarily (co-located array or distributed array or distributed antennae), as long as the effective beam patterns vary.

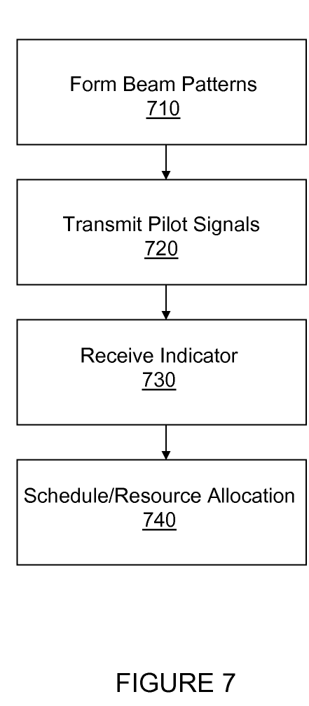

FIG. 7 is a flowchart illustrating exemplary steps executed to implement one embodiment of the present invention. In step 710, one or more beam patterns are formed at a first time by a transmitter, where the beam patterns include a first set used to transmit data during the first time, and a second set used to transmit probing signals during a subsequent time. A pilot signal is transmitted, in step 720, on each of the one or more beam patterns. In step 730, an indicator is received from one or more receivers, wherein the indicator relates to one of the beam patterns having a high channel quality. Transmission scheduling or resource allocation decisions are determined by the transmitter, in step 740, based, at least in part, on the indicator.

The program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a read-only memory (“ROM”), a flash memory, an erasable ROM (“EROM”), a floppy diskette, a compact disk (“CD-ROM”), an optical disk, a hard disk, a fiber optic medium, a radio frequency (“RF”) link, and the like. The computer data signal may include any signal that can propagate over a transmission medium such as electronic network channels, optical fibers, air, electromagnetic, RF links, and the like. The code segments may be downloaded via computer networks such as the Internet, Intranet, and the like.

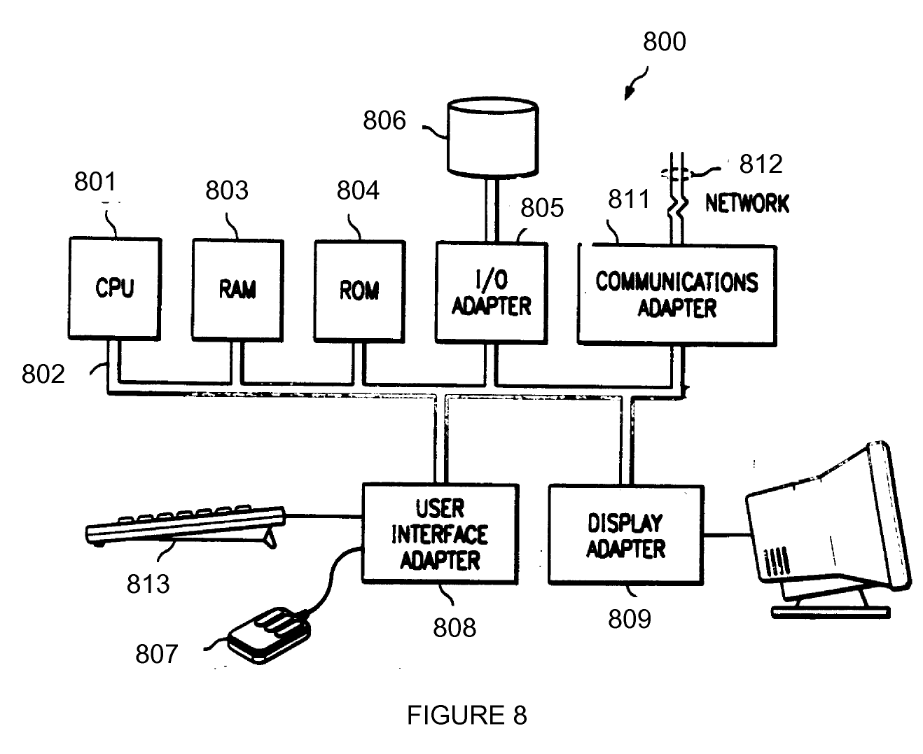

FIG. 8 illustrates computer system 800 adapted for use with embodiments of the present invention including storing and/or executing software associated therewith. A central processing unit (“CPU”) 801 is coupled to system bus 802. The CPU 801 may be any general purpose CPU. However, embodiments of the present invention are not restricted by the architecture of CPU 801 as long as CPU 801 supports the inventive operations as described herein. The bus 802 is coupled to random access memory (“RAM”) 803, which may be SRAM, DRAM, or SDRAM. A ROM 804 is also coupled to bus 802, which may be PROM, EPROM, or EEPROM. The RAM 803 and ROM 804 hold user and system data and programs as are well known in the art.

The bus 802 is also coupled to input/output (“I/O”) adapter 805, communications adapter 811, user interface adapter 808, and display adapter 809. The I/O adapter 805 connects storage devices 806, such as one or more of a hard drive, a CD drive, a floppy disk drive, and a tape drive, to computer system 800. The I/O adapter 805 is also connected to a printer (not shown), which would allow the system to print paper copies of information such as documents, photographs, articles, and the like. Note that the printer may be a printer (e.g., dot matrix, laser, and the like), a fax machine, scanner, or a copier machine.

Obviously, numerous variations and modifications can be made without departing from the spirit of the present invention. Therefore, it should be clearly understood that the form of the present invention described above and shown in the figures of the accompanying drawing is illustrative only and is not intended to limit the scope of the present invention.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof as described herein. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for a wireless communication system comprising:
forming one or more beam patterns at a first time by a transmitter, wherein said one or more beam patterns comprise at least:
a first set of said one or more beam patterns operable to transmit data during said first time, and
a second set of said one or more beam patterns, different, at least in part, from said first set, operable to transmit data during a subsequent time;
transmitting a pilot signal on at least said second set of said one or more beam patterns; and
managing scheduling and resource allocation based, at least in part, on an indicator received from one or more receivers, wherein said indicator relates to a quality of one or more of said one or more beam patterns.

2. The method of claim 1 further comprising scheduling data transmission to said one or more receivers at said subsequent time when said indicator relates to said one or more of said one or more beam patterns in said second set.

3. The method of claim 1, further comprising:
forming a transmission beam pattern corresponding to said one or more of said one or more beam patterns related to by said indicator; and
transmitting data to said one or more receivers using said transmission beam pattern.

4. The method of claim 1, further comprising:
receiving, at said one or more receivers, said pilot signal on each of said one or more beam patterns;
testing each of said one or more beam patterns;
determining which of said one or more beam patterns has a high channel quality; and
transmitting said indicator to said transmitter.

5. The method of claim 1 wherein said indicator comprises one of:
a channel quality indicator (“CQI”);
a signal identifying said one of said one or more beam patterns having a high channel quality; or
a designation for data transmission at one of:
said first time, when said one of said one or more beam patterns having said high channel quality is in said first set; or
said subsequent time, when said one or said one or more beam patterns having said high channel quality is in said second set.

6. The method of claim 1 further comprising:
indexing a first group of said one or more beam patterns for a first one of said one or more receivers; and
indexing one or more additional groups of said one or more beam patterns for one or more additional ones of said one or more receivers.

7. The method of claim 1 wherein said one or more beam patterns are formed orthogonal to each other.

8. A transmitter comprising:
a beam forming module configured to direct formation of one or more radio frequency beam patterns;
a pilot module configured to generate pilot signals transmittable using said one or more beam patterns;
a decoder configured to decode feedback signals from one or more receivers, wherein said feedback signals relate to ones of said one or more beam patterns having a high channel quality;
a scheduling module configured to schedule data transmission to said one or more receivers based at least in part on said decoded feedback signal; and
a resource allocation module configured to allocate ones of said one or more radio frequency (“RF”) beam patterns for said data transmission.

9. The transmitter of claim 8 further comprising:
an antennae interface configured to enable communication between said transmitter and one or more antennae, wherein said one or more antennae transmit RF signals to generate said one or more RF beam patterns, and wherein said feedback signals are received at said one or more antennae.

10. The transmitter of claim 8 wherein said feedback signal comprises one of:
a channel quality indicator (“CQI”);
a signal identifying one of said one or more RF beam patterns having said high channel quality; or
a designation for said data transmission at one of:
a first time, when said one of said one or more RF beam patterns having said high channel quality is used to transmit data during said first time; or
a subsequent time, when said one or said one or more RF beam patterns having said high channel quality is used to transmit data during said subsequent time.

11. A receiver comprising:
an antenna configured to receive one or more beam patterns transmitted by a transmitter, wherein said one or more beam patterns comprise:
a first set of said one or more beam patterns, wherein said first set is used to transmit data during said first time; and
a second set of said one or more beam patterns, wherein said second set is used to transmit data during a subsequent time;
a decoder configured to decode one or more pilot signals transmitted on said one or more beam patterns;
a test module configured to test a quality of said one or more beam patterns;
a quality indicator module configured to generate a quality indicator based on results output from said test module, wherein said quality indicator relates to one of said one or more beam patterns having a high channel quality; and
a coder configured to encode said quality indicator before transmission to said transmitter.

12. The receiver of claim 11 wherein said feedback signal comprises one of:
a channel quality indicator (“CQI”);
a signal identifying one of said one or more beam patterns having said high channel quality; or
a designation for receiving data transmission from said transmitter at one of:
said first time, when said one of said one or more beam patterns having said high channel quality is in said first set; or
said subsequent time, when said one or said one or more beam patterns having said high channel quality is in said second set.

13. The receiver of claim 11 wherein said one or more beam patterns are formed orthogonal to each other.

14. A computer program product having a computer readable medium with computer program logic recorded thereon, said computer program product comprising:
code for forming one or more beam patterns at a first time by a transmitter, wherein said one or more beam patterns comprise at least:
a first set of said one or more beam patterns operable to transmit data during said first time; and
a second set of said one or more beam patterns, different, at least in part, from said first set, operable to transmit data during a subsequent time;
code for transmitting a pilot signal on at least said second set of said one or more beam patterns; and
code for managing scheduling and resource allocation based, at least in part, on an indicator received from one or more receivers, wherein said indicator relates to a quality of one or more of said one or more beam patterns.

15. The computer program product of claim 14 further comprising:
code for scheduling data transmission to said one or more receivers at said subsequent time, when said indicator relates to said one or more of said one or more beam patterns in said second set.

16. The computer program product of claim 14 further comprising:
code for forming a transmission beam pattern corresponding to said one or more of said one or more beam patterns related to by said indicator; and
code for transmitting data to said one or more receivers using said transmission beam pattern.

17. The computer program product of claim 14 further comprising:
code for receiving at said one or more receivers, said pilot signal on each of said one or more beam patterns;
code for testing each of said one or more beam patterns;
code for determining which of said one or more beam patterns has a high channel quality; and
code for transmitting said indicator to said transmitter.

18. The computer program product of claim 14 wherein said indicator comprises one of:
a channel quality indicator (“CQI”);
a signal identifying said one of said one or more beam patterns having a high channel quality; or
a designation for data transmission at one of:
said first time, when said one of said one or more beam patterns having said high channel quality is in said first set; or
said subsequent time, when said one or said one or more beam patterns having said high channel quality is in said second set.

19. The computer program product of claim 14 further comprising:
code for indexing a first group of said one or more beam patterns for a first one of said one or more receivers; and
code for indexing one or more additional groups of said one or more beam patterns for one or more additional ones of said one or more receivers.

20. The computer program product of claim 14 wherein said one or more beam patterns are formed orthogonal to each other.
